(19) United States
(12) Patent Application Publication
(10) Pub. No.: US 2025/0098011 A1
(43) Pub. Date: Mar. 20, 2025

(54) A METHOD AND APPARATUS TO SEND USER CONSENT ON USER EQUIPMENT LOCATION

(71) Applicant: Samsung Electronics Co., Ltd., Suwon-si, Gyeonggi-do (KR)

(72) Inventors: Chadi KHIRALLAH, Staines (GB); Mahmoud WATFA, Staines (GB)

(21) Appl. No.: 18/726,655

(22) PCT Filed: Jan. 6, 2023
(86) PCT No.: PCT/KR2023/000268

§ 371 Date: Jul. 3, 2024

(30) Foreign Application Priority Data
Jan. 6, 2022 (GB) 2200089.7
Jan. 4, 2023 (GB) 2300104.3

(51) Int. Cl. H04W 76/20; H04W 76/30; H04W 84/06

(52) U.S. Cl. CPC H04W 76/20; H04W 76/30; H04W 84/06

(57) ABSTRACT

The disclosure relates to a 5G or 6G communication system for supporting a higher data transmission rate. The present invention relates to User Equipment, UE, location information and more particular to improvements in sending said UE location information to a network, particularly in a secure manner.

### TECHNICAL FIELD

The present invention relates to User Equipment, UE, location information and more particularly to improvements in sending said UE location information to a network, particularly in a secure manner.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for sending user consent on UE location.

### Solution to Problem

In accordance with an aspect of the present invention, a method of managing user consent for providing to a telecommunication network a location of a User Equipment (UE) performed by a user equipment includes transmitting, to a network entity, assistance information, receiving, from the network entity, a request or instruction to transmit the user consent; and transmitting, to the network entity, an radio resource control (RRC) message including the user consent, wherein the UE is arranged for connection to a satellite base station, gNB, of the telecommunication network.

In accordance with another aspect of the present invention, a method of managing user consent for a location of a user equipment (UE) performed by a first network entity includes receiving, from the (UE), assistance information, transmitting, to the UE, a request or instruction to transmit the user consent based on the assistance information, and receiving, from the UE, an radio resource control (RRC) message including the user consent, wherein the UE is arranged for connection to a satellite base station, gNB, of telecommunication network.

In accordance with another aspect of the present invention, a user equipment of managing user consent for providing to a telecommunication network a location of a User Equipment (UE), the user equipment includes a transceiver configured to transmit and receive a signal and a controller coupled with the transceiver and configured to transmit, to a network entity, assistance information, receive, from the network entity, a request or instruction to transmit the user consent; and transmit, to the network entity, an radio resource control (RRC) message including the user consent, wherein the UE is arranged for connection to a satellite base station, gNB, of the telecommunication network.

In accordance with another aspect of the present invention, a first network entity of managing user consent for a location of a user equipment (UE), the first network entity includes a transceiver configured to transmit and receive a signal; and a controller coupled with the transceiver and configured to receive, from the (UE), assistance information, transmit, to the UE, a request or instruction to transmit the user consent based on the assistance information; and receive, from the UE, an radio resource control (RRC) message including the user consent, wherein the UE is arranged for connection to a satellite base station, gNB, of telecommunication network.

### Advantageous Effects of Invention

Advantages, and salient features of the invention will become apparent to those skilled in the art from the following detailed description, which, taken in conjunction with the annexed drawings, discloses exemplary embodiments of the invention. Accordingly present invention, sending user consent on UE location can be performed efficiently.

### BRIEF DESCRIPTION OF DRAWINGS

FIG. 1 illustrates various scenarios regarding cross-border leakage in a satellite deployment.

FIG. 2 illustrates various scenarios regarding cross-border leakage in a satellite deployment.

FIG. 3 illustrates an example gNB according to embodiments of the present disclosure.

FIG. 4 illustrates an example UE according to embodiments of the present disclosure.

FIG. 5 illustrates an example of a network entity according to embodiments of the present disclosure.

### MODE FOR THE INVENTION

3GPP is developing solutions for the use of satellite access for connecting UEs to the Fifth Generation, 5G, core network. Selection of a Public Land Mobile Network, PLMN, while using satellite access is a key component of the feature and it is described in 3GPP specification TS 24.821.

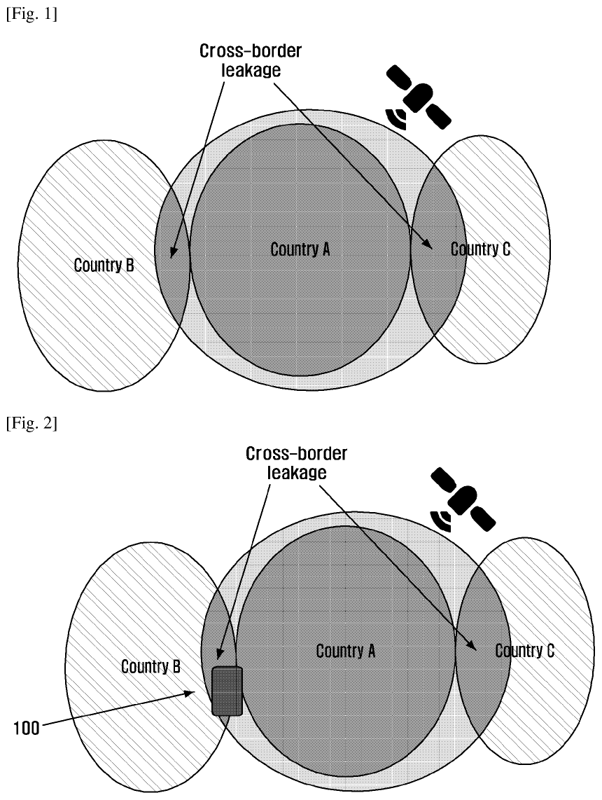

FIG. 1 shows one of the deployment options as described in TS 24.821. This shows that satellite coverage can actually span beyond a particular country for which it is intended (e.g. Country A) such that the coverage may unintentionally spread to other countries such as B and/or C as shown.

Assuming that the satellite coverage “leaks” into neighboring countries whereby a UE 100 in Country B receives/detects “leaked” coverage from a satellite that is providing coverage for Country A. This is shown in FIG. 2. In this case, the UE 100 will wrongly assume that it is in Country A since the PLMN ID (say e.g. PLMN A) that is detected by the UE (from the broadcast information of the cross-border leakage) will contain a Mobile Country Code (MCC) pointing to Country A.

Therefore, the detection of this cross-border leakage leads to a wrong PLMN selection of a UE i.e. the UE selects PLMN A (since it is detected) as opposed to the PLMN(s) within Country B where the UE is actually located.

The assumption so far in the prior art is that the UE provides its location to the Radio Access Network, RAN, node which, in turn, selects a suitable Access and Mobility Management Function, AMF, that could serve the UE in its current location.

Moreover, 3GPP has discussed the possibility of the user sending its consent to the network i.e. the consent is a form of an prior agreement from the user indicating that the provided user location information can indeed by used by the network.

As the UE may be expected to send user consent to the network. The precise method by which this should be sent is not yet specified. Embodiments of the present invention address this issue.

More particularly, embodiments aim to provide means whereby the user consent can be provided to the RAN node, so that the RAN node is aware whether it is allowed to request the UE location information (e.g. via RRC signalling), or the RAN node is allowed to configure the UE to provide its location information (with a given granularity/accuracy, location/area, time). Additionally, whether the RAN node is permitted to process the UE location information (e.g. in order to select a suitable AMF to serve the UE in current location).

Another problem is that the user consent policy information could be sent in the clear i.e. without any security protection. This is the case when the UE performs an initial registration without any previous security context that is shared with the selected PLMN. As such, in the process of sending the user consent policy information to the RAN, it may not be guaranteed that a rogue entity did not modify a negative user consent that may have been sent by the UE, where this rogue entity may actually end up sending a false UE location and a false positive consent that a (false) location information may be used for AMF selection.

It is an aim of embodiments of the present invention to address these and other issues in the prior art.

According to the present invention there is provided an apparatus and method as set forth in the appended claims. Other features of the invention will be apparent from the dependent claims, and the description which follows.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIGS. 1 and 2 illustrate various scenarios regarding cross-border leakage in a satellite deployment.

According to a first embodiment, there is provided means for sending user content to the network. In particular, three different options are provided.

The sending of the user consent may be based on a configuration in the UE, Mobile Equipment, ME, Universal Subscriber Identity Module, USIM, or based on user interaction, or any combination. The UE's decision to send a consent before or after security is established may be based on configuration (e.g. pre-configuration) in the UE as listed herein, or based on an indication from the network from a previous registration (release or reconfiguration, other, where this may have been done via any RRC message or NAS message). As such, when the UE registers to the network, the network should provide an indication or configuration to the UE which indicates if user consent should be sent with security, or without security, in a subsequent (initial) registration (or access) using either an RRC message or NAS message (a prior art or new message may be used for this purpose). As such, the configuration may be used with any option set out below. Alternatively, the UE may be configured by base station, gNB, (system information, dedicated RRC signalling) and/or Core Network, CN, (or any other suitable configuration method) to provide user consent assistance information with or without security in subsequent registration or during other operation mode (RRC Connected, Inactive, or Idle mode).

Note that in the solutions below, the term “user consent” may be a user consent only, or may also include location information where this location information may be based on any method e.g. based on Global navigation satellite system, GNSS, or other positioning methods, etc.

### Option 1

The UE sends the user consent using any RRC message e.g. RRCConnectionSetup-Complete message, or any other RRC message. The UE may send the user consent even if security is not yet setup based on a configuration in the UE as described above.

In one alternative, the UE may send the user consent after receiving an indication (in any RRC message) from the network to do so. Alternatively, if the network indicates that user consent is not to be sent, then the UE does not send the user consent. The network (e.g. RAN node and/or AMF) may determine to request the user consent, or not, based on a configuration in the network. Based on this configuration, the network indicates to the UE whether or not user consent should be sent, optionally with/before or without/after security. The network may be the gNB or the AMF. The network may do so using any prior art or new message (RRC and/or NAS).

### Option 2

The UE sends the user consent using any RRC message, however the user consent can only be sent after security is established. The decision to do so after security is established may be based on a configuration in the UE as described above. In one alternative, the UE may send the user consent after receiving an indication from the network to do so in any RRC message (prior art or a newly defined suitable message). As such the network indicates to the UE whether or not user consent is required to be sent. The network may do so using any prior art or new message (RRC and/or NAS).

In one alternative, the UE may send the user consent after receiving an indication (in any RRC message or any NAS message) from the network to do so. Alternatively, if the network indicates that user consent is not to be sent, then the UE does not send the user consent. The network (e.g. RAN node and/or AMF) may determine to request the user consent, or not, based on a configuration in the network.

### Option 3

In this option, the UE sends the user consent using any RRC message (or NAS message) before security is established (optionally based on a UE configuration to do so as described above). The user consent may be sent in any RRC message e.g. RRCConnectionSetupRequest message, RRCConnectionSetupComplete message (or any NAS message such as Registration Request). However, after the security is established, the UE should resend the consent again so that the network can verify whether the first/initially provided user consent is valid (e.g. was not modified by any rogue entity) or is up-to-date (e.g. user consent status may need to be updated (e.g. in terms of consent validity time, area, other) depending on the current UE location/area/country local policies or regulations).

Optionally, the decision to resend the user consent after security is established may be based on an indication (or solicitation) from the network in any RRC message (e.g. RRCReconfiguration message or a newly defined suitable message) or in any NAS message. Based on the value of the indication (e.g. to send the consent again after security, or not) then the UE determines whether the consent should be resent (same as initially sent consent information, or modified or with any additional information) or not after security is established.

The network (which may be the RAN e.g. gNB, or AMF) may be configured to receive a first user consent using any RRC/NAS message (optionally before security is established with the UE), optionally from the UE. The network may save this user consent and select a core network node (e.g. an AMF) based on the user consent and a UE location that the UE may have sent. The network may be configured to request the UE to re-transmit the user consent after security is established with the UE. When the network receives a re-transmitted user consent (or a second user consent), the network node may verify if the second user consent is the same as the first user consent. This enables the network to determine if both consents are the same or if the first consent was tampered with or modified by a rogue entity. If the network determines that the user consent was valid (e.g. based on the first consent being the same as the second consent), then the network node continues to serve the UE.

If the network determines that the user consent was invalid (e.g. based on the first consent not being the same as the second consent), then the network node determines to no longer serve the UE and may release the UE's RRC connection/NAS connection. The network may include a new cause code to indicate that the consent was not valid (note that any new RRC cause code may be used, or a prior art one may be used, or a new or prior art 5GMM cause value may be used). The network may also inform the AMF that the connection has been released due to an invalid user consent. A new cause value may also be used on the protocol message that runs between the RAN and the AMF.

If the UE's RRC connection/NAS connection is released after sending a second consent, optionally with a new cause value as described above, the UE may determine that the first user consent was tampered with. The UE may start a timer during which the UE considers the cell to be not suitable or as a barred cell. Upon expiry of the timer, the UE may use the cell and re-attempt. Alternatively, the UE may re-attempt connection directly regardless of when the UE attempts, the UE may subsequently determine to only send the user consent after the security is established. This change in sending the UE consent (i.e. to only send it after the security is established) may be based on a previous decision in the UE that a first consent was invalid or was modified by a rogue entity as described above.

The following provides further information on the options set out above.

In relation to handling user consent for UE location information in a non-terrestrial network, NTN (e.g. satellite), although the gNB is used below as an example, the details can also apply to the AMF where any existing or new NAS message may be used to carry similar information to achieve the method set out herein.

The gNB may send an indication to the UE to provide its “NTN specific user consent” (e.g. user consent assistance information, see below), to specify whether the gNB is allowed to handle UE location information (e.g. to find a suitable AMF to serve the UE in current location, or other), before this UE can report its location to gNB.

In relation to the gNB indication to UE to provide user consent:

The gNB can send the indication (e.g. nTNUserConsentIndication IE or any suitably named IE) using one or more of the following methods:
1. System Information broadcast (e.g., existing SIB, new SIB, or a separate message):
   1. Periodically or
   2. On-demand by the UE (i.e., MSG1/MSG3).
2. RRC signaling:
   1. RRC Reconfiguration (UE in RRC_CONNECTED state)
   2. RRC Release (on moving the UE to RRC_INACTIVE state or RRC_IDLE state).
   3. UEAssistanceInformation
   4. A newly defined suitable RRC message
   5. Other
3. NAS signaling

In relation to User consent assistance information:

The following is one possible content (or format) of the user consent assistance information that the UE can provide to the gNB (e.g. nTNUserConsentAssitanceInformation IE):
1. nTNUserConsentAssitanceInformation IE may include information on (e.g. UserConsent ID, LocationInformationConsent={Allowed, NotAllowed, Other}, Validity Timer/Time, Validity Area, Security Status={Protected, NotProtected, Other}, User Consent Version number={1st, 2nd, [symbol] , MaxNumber.}, User Conset Version Status={Updated, version date info, other), other).
2. UE may provide a simple indication to the gNB. For example: nTNUserConsentAssitanceInformation IE (e.g. 1 bit indication):
   nTNUserConsentAssitanceInformation IE set to “1”/True, indicates that the UE is allowed to send its location information to gNB and/or the gNB is allowed to process this information as needed.
   nTNUserConsentAssitanceInformation IE set to “0”/False, indicates that the UE is NOT allowed to send its location information to gNB and/or the gNB is NOT allowed to process this information as needed.
3. any combination of 1 and 2, above, and additional information (e.g. possible restrictions/limitations on the usage/processing of UE location information at gNB (e.g UE location information, obtained before security establishment, should only be used to select a suitable AMF for the UE in the current location).
4. any combination of the above options with (or without) any additional relevant information.

Note that similar IEs may be defined and used at the NAS layer or in NAS signalling.

In relation to UE behaviour to handle user consent in different UE RRC states, the following describes the UE behaviour to handle user consent:
1) Initial access case (optionally initial registration):
   a. If the UE obtains the gNB indication (e.g. nTNUserConsentIndication IE), via any of the methods above, to provide its user consent information on whether gNB is allowed to request, obtain (and/or process) UE location information or not, and if the nTNUserConsentIndication IE is set (e.g. to “True” or “1”), then the UE may provide its user consent assistance information (e.g. nTNUserConsentAssitanceInformation IE, or any other suitably named IE) via any suitable RRC message (e.g. RRC Setup Request massage [MSG3]).
   b. Otherwise, If the UE does not obtain the gNB indication (e.g. nTNUserConsentIndication IE), or the nTNUserConsentIndication IE is set (e.g. to “False”, or “0”), then the UE will not send its user consent assistance information to gNB (e.g. nTNUserConsentAssitanceInformation IE).
   c. The gNB may forward the user consent assistance information nTNUserConsentAssitanceInformation IE to the CN, e.g., to AMF (e.g. nTNUserConsentAssitanceInformation IE included in the Initial UE Message) so the AMF could verify (e.g. based on UE subscription pulled from UDM) whether the UE provided a valid user consent assistance information (e.g., not frudelent, tamperd with by any internal or external entity, information is out-of-date, or UE is allowed to provide its user consent information or even whether UE is allowed to share its location information with gNB or any other entity in its current location, area, country, etc).
   d. In addition to the confirmation that the user consent assistance information, reported by UE, is valid, the AMF may provide additional (more detailed) information to the UE and/or gNB related to the User Consent Policy (e.g. any updates on the policy info such as restrictions on usage of UE location information, user consent validity time/area, other, due to UE crossing into a different country).
i. This case may be related to simple UE incitation of user consent, as the UE may not provide this detailed information on user consent (only 1 bit indication case), hence, gNB may obtain the remaining/up-to-date user consent information from CN (i.e., AMF).
ii. The User Consent is in-correct/not-valid (e.g. UE is not allowed to provide user consent information and/or location information in this Area/Country/Location, time of the day, etc.)
   The AMF may accept the UE Registration Request, and may provide confirmation/indication to gNB and/or UE (e.g. nTNUserConsentPolicy Valid IE set to “True” or “False”)
   The AMF may accept UE Registration Request, and may provide confirmation/indication to gNB and/or UE (e.g. nTNUserConsentPolicy Valid IE set to “True” or “False”), and additional assistance information related to User Consent Policy (e.g. any updates in policy)
   The AMF may reject UE registration request to this location/country/area, and inform the UE and/or gNB of the cause for rejection, (e.g. NoValidUserConsent, NotValidUserConsent, NoValidUserConsenttoReportLocation, or any other suitable cause name).
2) RRC Connected/RRC Inactive/RRC Idle mode:
   a. gNB may configure UE to send its nTNUserConsentAssitanceInformation IE by including nTNUserConsentIndication IE in a sutiable RRC message (e.g. RRC Reconfiguration, RRCRelease, RRCRelease (with suspend) or any other).
   b. If UE nTNUserConsentIndication IE is set to “True”, the UE may provide nTNUserConsentAssitanceInformation IE to gNB in a suitable RRC message (e.g. RRCResumeRequest, RRCSetupRequest, RRCRestablishementRequest, UEAssistanceInformation, or using a new RRC message, or other).
   c. If nTNUserConsentIndication IE is set to “False” or not included in any RRC message to UE (e.g. due to security reasons the UE is not allowed to provide its user consent information and/or location at any granularity/accuracy to gNB). The UE may behave as follows:
      i. Option 1: the UE may not send the nTNUserConsentAssitanceInformation IE to the gNB
      ii. Option 2: the UE may send the nTNUserConsentAssitanceInformation IE and set it to “False”
   d. If the gNB receives nTNUserConsentAssitanceInformation IE={False}, or nTNUserConsentAssitanceInformation IE is not included in any RRC messages (e.g., RRCSetupRequest, etc), gNB may behave as follows:
      i. Alt-1: the gNB rejects the UE's RRC connection request (e.g. RRCReestablishmentRequest/RRCResumeRequest/RRCResumeRequest1/RRCSetupRequest message) by sending a suitable rejection message (e.g. RRCReject message to UE). The gNB may include a cause value of the reason for the rejection (e.g. NoValidUserConsent, NoUserConsent, NoUserConsenttoReportLocation, any other)
      ii. Alt-2: the gNB accepts the UE's RRC connection request (Setup/Resume, etc.)

The following show an example of RRC message update for gNB indication to UE:

| | | |
|---|---|---|
| RRCRelease-vxyz-IEs ::= | SEQUENCE { | |
| nTNUserConsentIndication-rxy | ENUMERATED {true} | OPTIONAL, -- Need N |
| nonCriticalExtension | RRCRelease-vxyz-IEs | OPTIONAL |

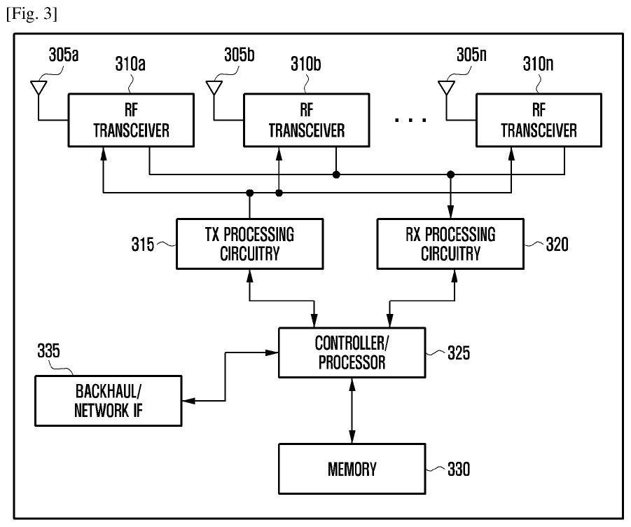

FIG. 3 illustrates an example gNB according to embodiments of the present disclosure.

The embodiment of the gNB illustrated in FIG. 3 is for illustration only, and the gNB could have the same or similar configuration. However, gNBs come in a wide variety of configurations, and FIG. 2 does not limit the scope of this disclosure to any particular implementation of a gNB.

As shown in FIG. 2, the gNB includes multiple antennas 305a-305n, multiple RF transceivers 310a-310n, transmit (TX) processing circuitry 315, and receive (RX) processing circuitry 320. The gNB also includes a controller/processor 325, a memory 330, and a backhaul or network interface 335.

The RF transceivers 310a-310n receive, from the antennas 305a-305n, incoming RF signals, such as signals transmitted by UEs in the network. The RF transceivers 310a-310n down-convert the incoming RF signals to generate IF or baseband signals. The IF or baseband signals are sent to the RX processing circuitry 320, which generates processed baseband signals by filtering, decoding, and/or digitizing the baseband or IF signals. The RX processing circuitry 320 transmits the processed baseband signals to the controller/processor 325 for further processing.

The TX processing circuitry 315 receives analog or digital data (such as voice data, web data, e-mail, or interactive video game data) from the controller/processor 325. The TX processing circuitry 215 encodes, multiplexes, and/or digitizes the outgoing baseband data to generate processed baseband or IF signals. The RF transceivers 310a-310n receive the outgoing processed baseband or IF signals from the TX processing circuitry 315 and up-converts the baseband or IF signals to RF signals that are transmitted via the antennas 305a-305n.

The controller/processor 325 can include one or more processors or other processing devices that control the overall operation of the gNB. For example, the controller/processor 325 could control the reception of forward channel signals and the transmission of reverse channel signals by the RF transceivers 310a-310n, the RX processing circuitry 320, and the TX processing circuitry 315 in accordance with well-known principles. The controller/processor 325 could support additional functions as well, such as more advanced wireless communication functions. For instance, the controller/processor 325 could support beam forming or directional routing operations in which outgoing/incoming signals from/to multiple antennas 305a-305n are weighted differently to effectively steer the outgoing signals in a desired direction. Any of a wide variety of other functions could be supported in the gNB by the controller/processor 325.

The controller/processor 325 is also capable of executing programs and other processes resident in the memory 330, such as an OS. The controller/processor 325 can move data into or out of the memory 330 as required by an executing process.

The controller/processor 325 is also coupled to the backhaul or network interface 335. The backhaul or network interface 335 allows the gNB to communicate with other devices or systems over a backhaul connection or over a network. The interface 335 could support communications over any suitable wired or wireless connection(s). For example, when the gNB is implemented as part of a cellular communication system (such as one supporting 5G/NR, LTE, or LTE-A), the interface 335 could allow the gNB to communicate with other gNBs over a wired or wireless backhaul connection (e.g., a wireless network link including a non-terrestrial node). When the gNB is implemented as an access point, the interface 335 could allow the gNB to communicate over a wired or wireless local area network or over a wired or wireless connection to a larger network (such as the Internet). The interface 335 includes any suitable structure supporting communications over a wired or wireless connection, such as an Ethernet or RF transceiver.

The memory 330 is coupled to the controller/processor 325. Part of the memory 330 could include a RAM, and another part of the memory 330 could include a Flash memory or other ROM.

Although FIG. 3 illustrates one example of gNB, various changes may be made to FIG. 3. For example, the gNB could include any number of each component shown in FIG. 3. As a particular example, an access point could include a number of interfaces 335, and the controller/processor 325 could support measurement of TAI updates in an NTN. For example, the gNB may be or may receive network access via a non-terrestrial node such as a satellite. As another particular example, while shown as including a single instance of TX processing circuitry 315 and a single instance of RX processing circuitry 320, the gNB could include multiple instances of each (such as one per RF transceiver). Also, various components in FIG. 3 could be combined, further subdivided, or omitted and additional components could be added according to particular needs.

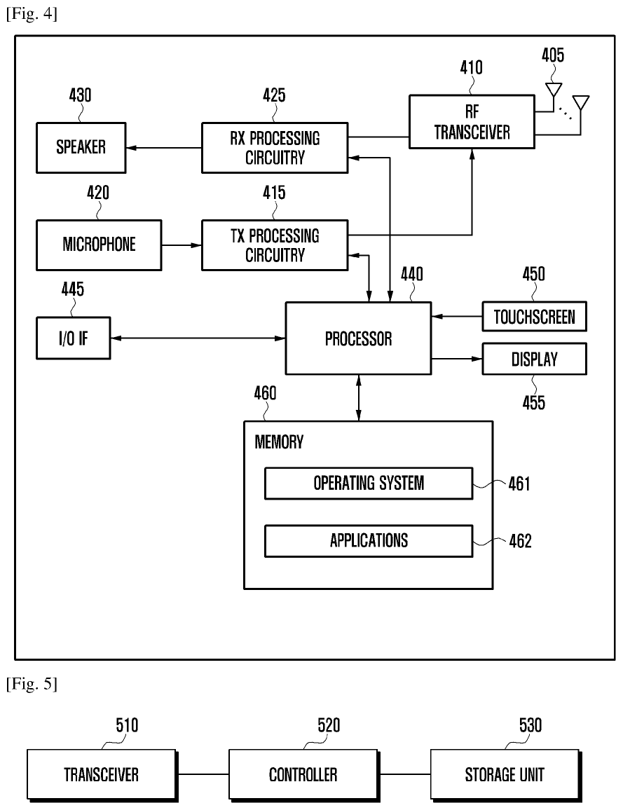

FIG. 4 illustrates an example UE according to embodiments of the present disclosure. The embodiment of the UE illustrated in FIG. 4 is for illustration only, and the UE could have the same or similar configuration. However, UEs come in a wide variety of configurations, and FIG. 4 does not limit the scope of this disclosure to any particular implementation of a UE.

As shown in FIG. 4, the UE includes an antenna 405, a radio frequency (RF) transceiver 410, TX processing circuitry 415, a microphone 420, and receive (RX) processing circuitry 425. The UE also includes a speaker 430, a processor 440, an input/output (I/O) interface (IF) 445, a touchscreen 450, a display 455, and a memory 460. The memory 460 includes an operating system (OS) 461 and one or more applications 462.

The RF transceiver 410 receives, from the antenna 405, an incoming RF signal transmitted by a gNB of the network. The RF transceiver 410 down-converts the incoming RF signal to generate an intermediate frequency (IF) or baseband signal. The IF or baseband signal is sent to the RX processing circuitry 425, which generates a processed baseband signal by filtering, decoding, and/or digitizing the baseband or IF signal. The RX processing circuitry 425 transmits the processed baseband signal to the speaker 330 (such as for voice data) or to the processor 440 for further processing (such as for web browsing data).

The TX processing circuitry 415 receives analog or digital voice data from the microphone 420 or other outgoing baseband data (such as web data, e-mail, or interactive video game data) from the processor 440. The TX processing circuitry 415 encodes, multiplexes, and/or digitizes the outgoing baseband data to generate a processed baseband or IF signal. The RF transceiver 410 receives the outgoing processed baseband or IF signal from the TX processing circuitry 415 and up-converts the baseband or IF signal to an RF signal that is transmitted via the antenna 405.

The processor 440 can include one or more processors or other processing devices and execute the OS 461 stored in the memory 460 in order to control the overall operation of the UE. For example, the processor 440 could control the reception of forward channel signals and the transmission of reverse channel signals by the RF transceiver 410, the RX processing circuitry 425, and the TX processing circuitry 415 in accordance with well-known principles. In some embodiments, the processor 440 includes at least one microprocessor or microcontroller.

The processor 440 is also capable of executing other processes and programs resident in the memory 460, such as processes for measurement of TAI updates in an NTN. For example, in various embodiments, the UE may communicate directly or indirectly with a non-terrestrial node such as a satellite. The processor 440 can move data into or out of the memory 460 as required by an executing process. In some embodiments, the processor 440 is configured to execute the applications 462 based on the OS 461 or in response to signals received from gNBs or an operator. The processor 440 is also coupled to the I/O interface 445, which provides the UE with the ability to connect to other devices, such as laptop computers and handheld computers. The I/O interface 445 is the communication path between these accessories and the processor 440.

The processor 440 is also coupled to the touchscreen 450 and the display 455. The operator of the UE can use the touchscreen 450 to enter data into the UE. The display 455 may be a liquid crystal display, light emitting diode display, or other display capable of rendering text and/or at least limited graphics, such as from web sites.

The memory 460 is coupled to the processor 440. Part of the memory 460 could include a random access memory (RAM), and another part of the memory 460 could include a Flash memory or other read-only memory (ROM).

Although FIG. 4 illustrates one example of UE, various changes may be made to FIG. 4. For example, various components in FIG. 4 could be combined, further subdivided, or omitted and additional components could be added according to particular needs. As a particular example, the processor 440 could be divided into multiple processors, such as one or more central processing units (CPUs) and one or more graphics processing units (GPUs). Also, while FIG. 4 illustrates the UE configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

FIG. 5 illustrates an example of a network entity according to embodiments of the present disclosure.

The network entity may correspond to the AMF node in the respective embodiments. Referring to FIG. 5, the network entity may include a transceiver 510, a controller 520, and a storage unit 530. The controller 520 may be defined as a circuit, an application-specific integrated circuit, or at least one processor. The transceiver 510 may transmit/receive signals to/from other network entities. The controller 520 may control overall operations of the UE. The storage unit 530 may store at least one piece of information transmitted/received through the transceiver 510 and information produced through the controller 520.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store [symbol] ). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above subcomponents may be omitted, or additional other sub-components may be further included. Alternatively or additionally, some components may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of managing user consent for providing to a telecommunication network a location of a User Equipment (UE) performed by a user equipment, the method comprising:
transmitting, to a network entity, assistance information;
receiving, from the network entity, a request or instruction to transmit the user consent; and
transmitting, to the network entity, an radio resource control (RRC) message including the user consent,
wherein the UE is arranged for connection to a satellite base station, gNB, of the telecommunication network.

2. The method of claim 1,
wherein the user consent is updated in the event of any change.

3. A method of managing user consent for a location of a user equipment (UE) performed by a first network entity, the method comprising:
receiving, from the (UE), assistance information;
transmitting, to the UE, a request or instruction to transmit the user consent based on the assistance information; and
receiving, from the UE, an radio resource control (RRC) message including the user consent,
wherein the UE is arranged for connection to a satellite base station, gNB, of telecommunication network.

4. The method of claim 3, the method further comprising:
releasing the UE based on the user consent.

5. The method of claim 4, the method further comprising:
transmitting, to a second network entity, information associated with the cause of the releasing.

6. The method of claim 3, the method further comprising:
storing detail of the user consent.

7. The method of claim 3, the method further comprising:
selecting a core network node based on the user consent and the UE location information.

8. The method of claim 3, the method further comprising:
exchanging, with a second network entity, at least one of user consent or assistance information via next generation (NG) interface.

9. A user equipment of managing user consent for providing to a telecommunication network a location of a User Equipment (UE), the user equipment comprising:
a transceiver configured to transmit and receive a signal; and
a controller coupled with the transceiver and configured to transmit, to a network entity, assistance information, receive, from the network entity, a request or instruction to transmit the user consent; and
transmit, to the network entity, an radio resource control (RRC) message including the user consent, wherein the UE is arranged for connection to a satellite base station, gNB, of the telecommunication network.

10. The user equipment of claim 9,
wherein the user consent is updated in the event of any change.

11. A first network entity of managing user consent for a location of a user equipment (UE), the first network entity comprising:
a transceiver configured to transmit and receive a signal; and
a controller coupled with the transceiver and configured to receive, from the (UE), assistance information, transmit, to the UE, a request or instruction to transmit the user consent based on the assistance information; and receive, from the UE, an radio resource control (RRC) message including the user consent,
wherein the UE is arranged for connection to a satellite base station, gNB, of telecommunication network.

12. The first network entity of claim 11,
the controller is further configured to release the UE based on the user consent, and transmit, to a second network entity, information associated with the cause of the releasing.

13. The first network entity of claim 11,
the controller is further configured to store detail of the user consent.

14. The first network entity of claim 11,
the controller is further configured to select a core network node based on the user consent and the UE location information.

15. The first network entity of claim 11,
the controller is further configured to exchange, with a second network entity, at least one of user consent or assistance information via next generation (NG) interface.
